(19) United States
(12) Patent Application Publication
(10) Pub. No.: US 2021/0331567 A1
(43) Pub. Date: Oct. 28, 2021

(54) TRUCK BED COVER

(71) Applicant: Gregory M. Selinger, Napes, FL (US)

(72) Inventor: Gregory M. Selinger, Napes, FL (US)

(21) Appl. No.: 17/370,273

(22) Filed: Jul. 8, 2021

Related U.S. Application Data
(63) Continuation-in-part of application No. 16/550,445, filed on Aug. 26, 2019.

(51) Int. Cl. B60J 7/16; B60P 3/34

(52) U.S. Cl. CPC B60J 7/1621; B60P 3/341

(57) ABSTRACT

A truck bed cover (1) having a base unit (4) that provides a user with multiple storage configurations, increased access to a truck bed (28) and increased functionality. In addition, the base unit provides attachment points for a hinged truck bed cap (19) and/or a tonneau cover (35). At least one panel (36) may be attached between the cap and a truck bed to create a tented enclosure (37).

### CROSS-REFERENCE TO RELATED APPLICATION

This application is a continuation-in-part of application Ser. No. 16/550,445 filed on Aug. 26, 2019, which is currently pending. The patent application identified above is incorporated herein by reference in their entirety to provide continuity of disclosure.

### FIELD OF THE INVENTION

This invention relates generally to covers for pickup truck beds, and more particularly relates to a truck bed cover having a base unit that provides a user with multiple storage configurations, increased access to the truck bed and increased functionality.

### BACKGROUND OF THE INVENTION

It is often desirable to cover a bed of a pickup truck to protect the contents from inclement weather and to provide a measure of security. Conventional truck bed covers, also referred to as caps, shells, toppers and so forth, are fabricated as large single units that cover an entire bed of a truck and are generally left in place on the truck bed after being installed.

Conventional truck toppers generally have a U-shaped body formed from a roof and two walls. A rear window situated over a truck's tailgate generally provides the only entry and access point to the interior of the truck topper and truck bed, thereby leaving the front of the truck bed virtually unusable for smaller items that need to be easily removed from the bed of the truck on a regular basis.

An additional problem with conventional truck caps is that they are difficult to remove if an individual needs an open bed for hauling materials and/or simply prefers to have an open bed when the cap is not needed.

Therefore, a need exists for a truck bed cover having a base unit that provides a user with multiple storage configurations, increased access to the truck bed and increased functionality of the truck.

### SUMMARY OF THE INVENTION

The primary object of the present invention is to provide a truck bed cover having a base unit that provides a user with multiple storage configurations, increased access to the truck bed and increased functionality.

An additional object of the present invention is to provide a truck bed cover that provides a structure for camping when extended into an open position.

The present invention fulfills the above and other objects by providing a truck bed cover having a base unit for that attaches to a front rail and side rails of a truck bed. The base unit only extends down a limited portion of the side rails. The base unit is made up of side panels and a roof panel that extend backward a cab of the truck, thereby extending the profile of the cab of the truck, providing storage compartments and providing attachment points for a cap or tonneau cover to cover the remaining portion of the truck bed.

The base unit provides a foundation for providing storage options as well as a support for a bed cap having side panels and a roof panel that cover the portion of the bed left uncovered by the base unit. The roof panel of the bed cap is hingedly attached to the roof panel of the base unit, thereby allowing the bed cap to be lifted upward from a tailgate of the truck to expose the bed of the pickup truck for side access. Rear side edges of the base unit and corresponding front side edges of the bed cap are preferably angled to allow clearance for the bed cap to pivot upward away from the base unit.

Optional nylon and/or mesh panels may be added to bottom edges of the bed cap to create an enclosure surrounding the bed of the truck for camping when the bed cap is in an open position and the panels are secured between the bed cap and the bed of the vehicle.

In addition, the bed cap may be removed from the base unit leaving the base unit in place on the truck. The base unit may be left on the truck when the bed cap is removed to provide additional covered storage space and an enhanced profile to the cab of the truck. The base unit may be enclosed with side and/or rear doors to provide internal storage within the base unit. Likewise, one or more cargo racks, roof racks, side rails may be located on the base unit and/or bed cap.

The base unit may also be used with a tonneau bed cover that engages a rear edge of the base unit and covers the remaining portion of the truck bed.

Bed rail covers may extend from the base unit to engage side edges of the bed cap or tonneau bed cover. The bed rail covers may provide tie downs, cargo rails and so forth.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective passenger side view of a truck bed cover in use on a truck wherein a bed cap of the present invention is in a closed position;

FIG. 2 is a perspective passenger side view of a truck bed cover in use on a truck wherein a bed cap of the present invention is in an open position;

FIG. 3 is perspective passenger side view of a truck bed cover in use on a truck wherein a bed cap of the present invention has been removed from the base unit;

FIG. 4 is a truck bed cover in use on a truck wherein a base unit of the present invention is in use with a tonneau cover of the present invention in a closed position;

FIG. 5 is a truck bed cover in use on a truck wherein a base unit of the present invention is in use with a tonneau cover of the present invention in an open position; and

FIG. 6 is a perspective passenger side view of a truck bed cover in use on a truck wherein a bed cap of the present invention is in an open position and having panels secured thereto for creating an enclosure.

### DESCRIPTION OF THE PREFERRED EMBODIMENTS

For purposes of describing the preferred embodiment, the terminology used in reference to the numbered accessories in the drawings is as follows:

1. truck bed cover, generally

2. truck

3. bed cap

4. base unit

5. roof panel of base unit

6. driver side panel of base unit

7. passenger side panel of base unit

8. front panel of base unit

9. rear panel of base unit

10. bottom panel of base unit

11. vertical front edge of driver side panel

12. top edge of driver side panel

13. bottom edge of driver side panel

14. rear edge of driver side panel

15. vertical front edge of passenger side panel

16. top edge of passenger side panel

17. bottom edge of passenger side panel

18. rear edge of passenger side panel

19. bed cap

20. roof panel of bed cap

21. driver side panel of bed cap

22. passenger side panel of bed cap

23. rear panel of bed cap

24. front edge of roof panel of bed cap

25. rear edge of roof panel of base unit

26. hinge

27. tailgate

28. bed of truck

29. front edge of driver side panel of bed cap

30. front edge of passenger side panel of bed cap

31. front bottom corner of bed cap

32. bed rail cover

33. storage accessory

34. cab of truck

35. tonneau cover

36. panel

37. enclosure

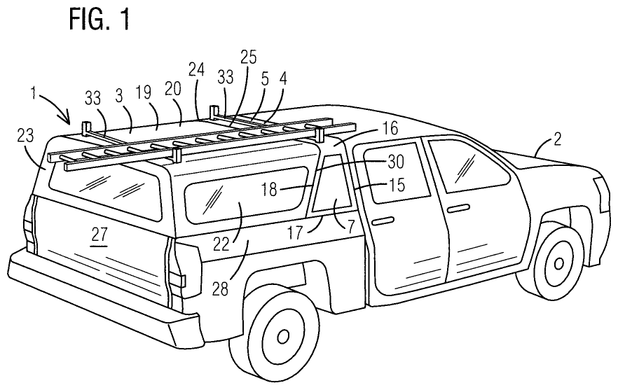

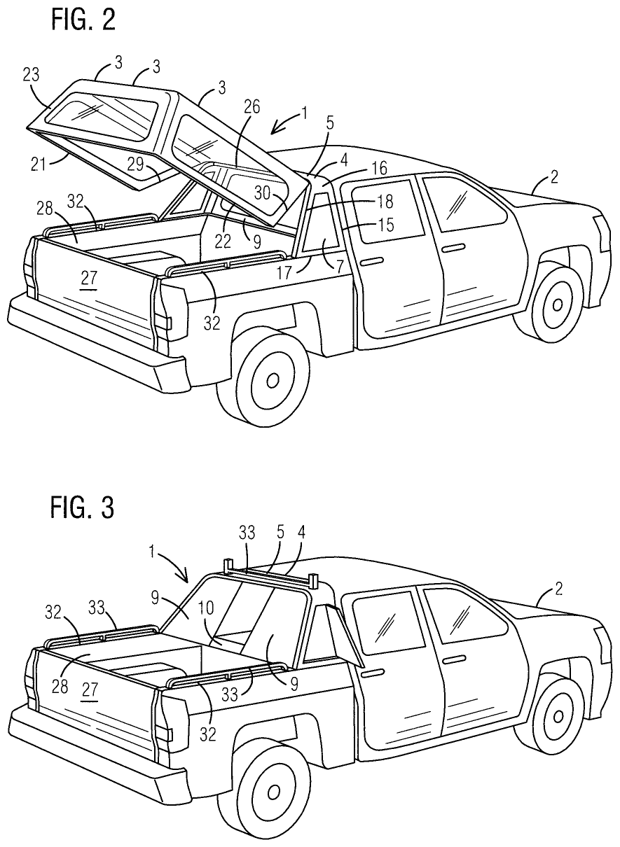

With reference to FIGS. 1 and 2, a truck bed cover 1 in use on a truck 2 wherein a bed cap 3 of the present invention is in a closed position and open position, respectively, are illustrated. The truck bed cover 1 comprises a substantially U-shaped base unit 4 having a roof panel 5, a driver side panel 6 and a passenger side panel 7. The base unit 4 may further comprise at least one front panel 8, at least one rear panel 9, and at least one bottom panel 10, as further illustrated in FIG. 3.

The driver side panel 6 of the base unit 4 is preferably trapezoidal-shaped wherein a vertical front edge 11 of the driver side panel 6 is perpendicular to a horizontal top edge 12 and horizontal bottom edge 13 of the driver side panel 6. The top edge 12 of the driver side panel 6 is preferably shorter in length than the bottom edge 13 of the driver side panel 6, thereby causing a rear edge 14 of the driver side panel 6 to be angled.

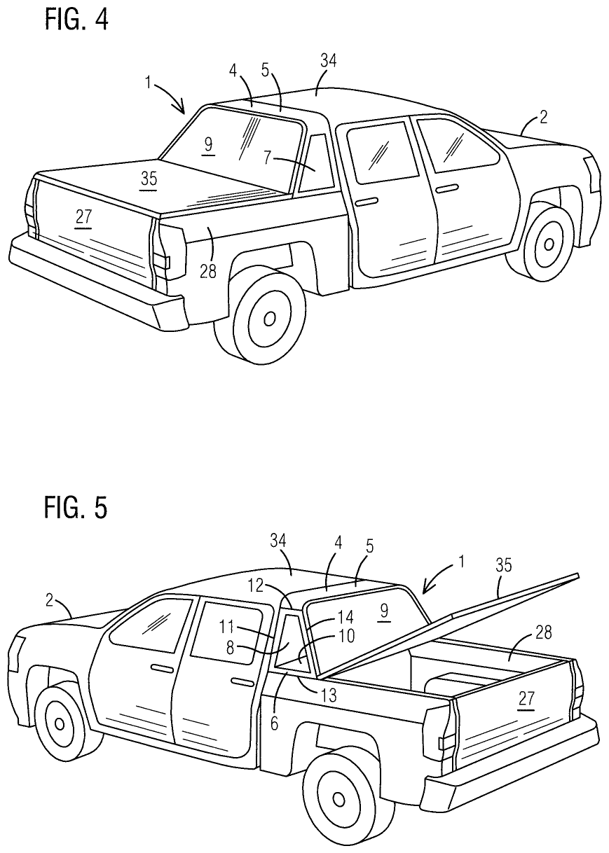

In addition, the passenger side panel 7 of the base unit 4, as further illustrated in FIG. 4, is preferably trapezoidal-shaped wherein a vertical front edge 15 of the passenger side panel 7 is perpendicular to a horizontal top edge 16 and horizontal bottom edge 17 of the passenger side panel 7. The top edge 16 of the passenger side panel 7 is preferably shorter in length than the bottom edge 17 of the passenger side panel 7, thereby causing a rear edge 18 of the passenger side panel 7 to be angled.

A bed cap 19 hingedly attaches to the base unit 2 and comprises a roof panel 20, a driver side panel 21, a passenger side panel 22 and a rear panel 23. Said roof panel 20 of said bed cap 19 having a front edge 24 that attaches to a rear edge 25 of said roof panel 5 of said base unit 4 via at least one hinge 26, thereby allowing the bed cap 19 to be lifted upward from a tailgate 27 of the truck 2 to expose a bed 28 of the truck 2 for side access and/or to accommodate a tall piece of cargo.

A front edge 29 of the driver side panel 21 is angled to correspond to the angled rear edge 14 of the driver side panel 6 of the base unit 4. Likewise, a front edge 30 of the passenger side panel 21 is angled to correspond to the angled rear edge 18 of the passenger side panel 7 of the base unit 4. The corresponding angles provide clearance for front bottom corners 31 the bed cap 19 to pivot upward and away from the base unit 4, as illustrated in FIG. 2. Alternatively, the bed cap 19 may be removed leaving the base unit 4 in place on the truck bed 28.

Bed rail covers 32 may extend from the base unit 4. One or more storage accessories 33, such as tie downs, cargo rails and so forth, may be located on the roof panel 5 of the base unit 4, the roof panel 20 of the bed cap 21, the bed rail covers 32 and so forth. When the bed cap 19 is in a closed position, any storage accessories 33 located on the bed rail covers 32 are preferably enclosed within the bed cap 19.

With reference to FIG. 3, a truck bed cover 1 in use on a truck 2 wherein a bed cap 3 of the present invention has been removed from the base unit 4 is illustrated. The base unit 4 may be left on the truck 2 after the bed cap 19 has been removed to provide additional covered storage space directly behind the cab 34 and/or to extend and enhance a profile of the cab 34.

The truck bed cover 1 comprises a substantially U-shaped base unit 4 having a roof panel 5, a driver side panel 6 and a passenger side panel 7. Said driver side panel 6 of said base unit 4 may be hingedly attached to the base unit 4 to provide access to an interior space of the base unit 4. Likewise, said passenger side panel 7 of said base unit 4 may be hingedly attached to the base unit 4 to provide access to an interior space of the base unit 4.

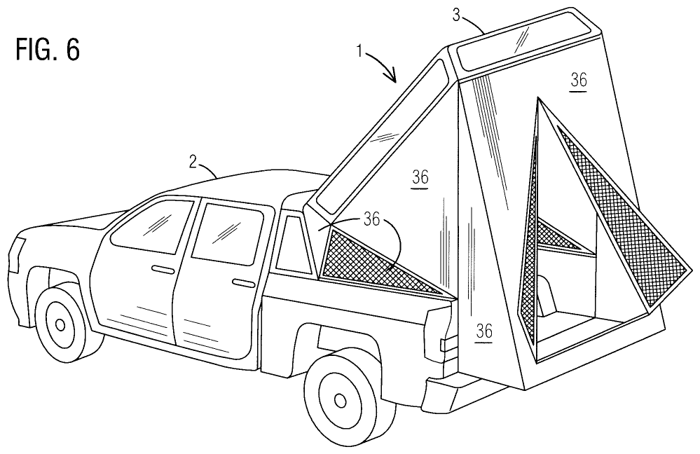

The base unit 4 may further comprise at least one front panel 8, at least one rear panel 9, and at least one bottom panel 10 wherein said at least one rear panel 9 of said base unit 4 may be hingedly attached to the base unit 4 to provide access to an interior space of the base unit 4, as further illustrated in FIG. 5.

The driver side panel 6 of the base unit 4 is preferably trapezoidal-shaped wherein a vertical front edge 11 of the driver side panel 6 is perpendicular to a horizontal top edge 12 and horizontal bottom edge 13 of the driver side panel 6. The top edge 12 of the driver side panel 6 is preferably shorter in length than the bottom edge 13 of the driver side panel 6, thereby causing a rear edge 14 of the driver side panel 6 to be angled.

In addition, the passenger side panel 7 of the base unit 4, as further illustrated in FIG. 4, is preferably trapezoidal-shaped wherein a vertical front edge 15 of the passenger side panel 7 is perpendicular to a horizontal top edge 16 and horizontal bottom edge 17 of the passenger side panel 7. The top edge 16 of the passenger side panel 7 is preferably shorter in length than the bottom edge 17 of the passenger side panel 7, thereby causing a rear edge 18 of the passenger side panel 7 to be angled.

With reference to FIGS. 4 and 5, a truck bed cover 1 in use on a truck 2 wherein a base unit 4 of the present invention is in use with a tonneau cover 35 of the present invention in a closed position and in an open position, respectively, are illustrated. The truck bed cover 1 comprises a substantially U-shaped base unit 4 having a roof panel 5, a driver side panel 6 and a passenger side panel 7. The base unit 4 may further comprise at least one front panel 8, at least one rear panel 9, and at least one bottom panel 10, as further illustrated in FIG. 5.

The base unit 4 may be left on the truck 2 after the bed cap 19 has been removed to provide additional covered storage space directly behind the cab 34 and/or to extend and enhance a profile of the cab 34. Alternatively, a tonneau cover 35 may be hingedly attached to the base unit 4, thereby allowing a user to alternate between an uncovered bed 28, a bed covered by a full sized bed cap 19 and a bed 28 covered by a tonneau cover 35.

With reference to FIG. 6, a perspective passenger side view of a truck bed cover 1 in use on a truck 2 wherein a bed cap 3 of the present invention is in an open position and has panels 36 secured thereto for creating an enclosure 37 is illustrated. One or more panels 36 may be attached to bottom edges of the bed cap 3 using any suitable attachment means. The panels 36 also attach to the bed 28 of the truck using any suitable attachment means. The panels 36 are preferably flexible nylon or mesh to create a tented enclosure 37 surrounding the bed 28 of the truck for camping.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A truck bed cover comprising:
a substantially U-shaped base unit having at least one roof panel, at least one driver side panel and at least one passenger side panel;
said driver side panel of the base unit being trapezoidal-shaped wherein a vertical front edge of the driver side panel is perpendicular to a horizontal top edge of the driver side panel and horizontal bottom edge of the driver side panel;
said top edge of the driver side panel of the base unit being shorter in length than the bottom edge of the driver side panel of the base unit, thereby causing a rear edge of the driver side panel of the base unit to be angled;
said passenger side panel of the base unit being trapezoidal-shaped wherein a vertical front edge of the passenger side panel is perpendicular to a horizontal top edge of the passenger side panel and horizontal bottom edge of the passenger side panel; and
said top edge of the passenger side panel of the base unit being shorter in length than the bottom edge of the passenger side panel of the base unit, thereby causing a rear edge of the passenger side panel of the base unit to be angled;
a bed cap having a roof panel, a driver side panel, a passenger side panel and a rear panel;
said roof panel of said bed cap having a front edge that hingedly attaches to a rear edge of said roof panel of said base unit, thereby allowing the bed cap to be lifted upward from a tailgate of a truck on which the truck bed cover is installed to expose a bed of the truck for side access;
at least one panel attached to bottom edges of the bed cap;
said at least one panel being attachable to a bed of the truck; and
said at least one panel creating a tented enclosure below the bed cap when the bed cap is in an open position.

2. The truck bed cover of claim 1 wherein:
said at least one panel is nylon.

3. The truck bed cover of claim 1 wherein:
said at least one panel is mesh.

4. The truck bed cover of claim 2 wherein:
said at least one panel is also mesh.
